(19) United States
(12) Patent Application Publication
(10) Pub. No.: US 2026/0059510 A1
(43) Pub. Date: Feb. 26, 2026

(54) SYSTEMS AND METHODS FOR IN-BAND REJECTION FILTER FOR SELF SUFFICIENCY IN BROADBAND WIRELESS COMMUNICATION

(71) Applicant: Ondas Networks Inc., Sunnyvale, CA (US)

(72) Inventor: Menashe SHAHAR, Los Altos, CA (US)

(73) Assignee: Ondas Networks Inc., Sunnyvale, CA (US)

(21) Appl. No.: 19/140,828

(22) PCT Filed: Feb. 27, 2025
(86) PCT No.: PCT/US2025/017518

§ 371 Date: Jun. 18, 2025

Related U.S. Application Data
(60) Provisional application No. 63/558,990, filed on Feb. 28, 2024.
(60) Provisional application No. 63/635,454, filed on Apr. 17, 2024.

(51) Int. Cl. H04W 72/0453; H04W 72/30

(52) U.S. Cl. CPC H04W 72/0453; H04W 72/30

(57) ABSTRACT

A system and method for an In-Band Rejection Filter (IBR) to filter varying combination of subchannels within a frequency band is provided. A bitmap configuration that specifies active subchannels within the frequency band can be used to determined filter coefficients for the IBR filter to reject interference from inactive subchannels while allowing signals from active subchannels to pass through.

### CROSS REFERENCE TO RELATED APPLICATIONS

This U.S. national phase patent application claims the benefit of and priority to PCT/US25/17518 filed on Feb. 27, 2025 which claims benefit of and priority to U.S. provisional patent application No. 63/558,990 filed on Feb. 28, 2024 and U.S. provisional patent application No. 63/635,454 filed on Apr. 17, 2024, incorporated herein by reference in their entireties.

### FIELD OF THE INVENTION

The invention relates generally to wireless communication systems (e.g., Point to Multipoint (PtMP) wireless communications systems) and Mission Critical IOT. In particular, the invention relates to communication of data over adjacent or non-adjacent frequency bands that are typically used for transmission of Push to Talk (PTT) voice and/or low speed data.

### BACKGROUND

Currently, wireless communications systems are employed to transmit voice and/or data between participants. As is known in the art, in order to communicate voice and/or data wirelessly, electromagnetic signals are sent and received using a particular frequency.

Some wireless communications systems are deployed to service particular geographical regions and/or particular organizations. In some scenarios, governments assign particular frequency ranges (e.g., bands) to be used only by particular organizations and/or entities such that a particular organization's network can be limited to communicate within an assigned frequency band. Many mission critical industries (e.g., railroads, electrical utilities, oil, and/or gas) can have private telecommunication systems that operate over assigned frequency as can be assigned by regulatory organizations (e.g., United States the Federal Communications Commission (FCC)). For example, PtMP wireless communications systems can operate over a PLMR band having one or more PLMR channels that are assigned.

In some instances, the assigned frequency band is often divided into narrower frequency channels. Currently, radio frequency filters can be used to remove signals from frequencies in the lower and higher margins of a channel. A channel may be partitioned into one or more equal size subchannels, which can serve as a minimal entity for band allocation in the frequency domain.

In some instances, one or more subchannels can be grouped to provide a wider bandwidth for a service. The subchannels within the one or more subchannel groups may be adjacent or non-adjacent to each other, typically indicated by a subchannel bit map. In the case of non-adjacent subchannels group, a filter can remove signals not only from the outer margins of the frequency range, but also filter out signal from subchannels within the channel frequency range.

Therefore, it can be desirable to have a dynamic filter that can filter inactive subchannels and/or signals in the outer margins of the frequency range for varying subchannel bit maps of the various signals received.

### SUMMARY OF THE INVENTION

The invention can involve a method for an In-Band Rejection Filter (IBR) to filter varying combination of subchannels within a frequency band. The method can involve receiving, by a processor, a first bitmap configuration that specifies active subchannels within the frequency band. The method can involve determining, by the processor, a first set of magnitudes of a frequency response based on the first bit map configuration. The method can involve determining, by the processor, a first set of filter coefficients for the IBR filter based on the first set of magnitudes. The method can involve applying, by the processor, the IBR filter with the first set of filter coefficients to the frequency band to reject interference from inactive subchannels while allowing signals from active subchannels to pass through. The method can involve receiving, by the processor, a second bitmap configuration that specifies active subchannels within the frequency band. The method can involve determining, by the processor, a second set of magnitudes of a frequency response based on the first bit map configuration. The method can involve determining, by the processor, a second set of filter coefficients for the IBR filter based on the first set of magnitudes. The method can involve applying, by the processor, the IBR filter with the second set of filter coefficients to the frequency band to reject interference from inactive subchannels while allowing signals from active subchannels to pass through, wherein the first bitmap configuration and the second bitmap configuration are different.

In some embodiments, wherein subchannels within the frequency band are unequally spaced. In some embodiments, determining the first set of filter coefficients further comprises iteratively applying, by the processor, weighted least squares to the first set of filter coefficients to achieve an equiripple pattern in the passband, stopband or both of the IBR.

In some embodiments, determining the second set of filter coefficients further comprises iteratively applying, by the processor, weighted least squares to the first set of filter coefficients to achieve an equiripple pattern in the passband, stopband or both of the IBR.

In some embodiments, the method also involves applying, by the processor, a Kaiser window to the IBR having the first set of filter coefficients, the second set of filter coefficients, or both. In some embodiments, the first bitmap configuration or the second bitmap configuration is dynamically updated based on real-time network conditions or user requirements.

In some embodiments, the method also involves a feedback loop to adjust the first set of magnitude, second set of magnitudes, or both in response to detected interference levels.

In another aspect, the invention includes an In-Band Rejection Filter (IBR) to filter varying combination of subchannels within a frequency band. The IBR filter can include one or more processors configured to receive a first bitmap configuration that specifies active subchannels within the frequency band. The one or more processors can be configured to determine a first set of magnitudes of a frequency response based on the first bit map configuration. The one or more processors can be configured to determine a first set of filter coefficients for the IBR filter based on the first set of magnitudes. The one or more processors can be configured to apply the IBR filter with the first set of filter coefficients to the frequency band to reject interference from inactive subchannels while allowing signals from active subchannels to pass through. The one or more processors can be configured to receive a second bitmap configuration that specifies active subchannels within the frequency band. The one or more processors can be configured to determine a second set of magnitudes of a frequency response based on the first bit map configuration. The one or more processors can be configured to determine a second set of filter coefficients for the IBR filter based on the first set of magnitudes. The one or more processors can be configured to apply the IBR filter with the second set of filter coefficients to the frequency band to reject interference from inactive subchannels while allowing signals from active subchannels to pass through, wherein the first bitmap configuration and the second bitmap configuration are different.

In some embodiments, the subchannels within the frequency band are unequally spaced. In some embodiments, determine the first set of filter coefficients further comprises iteratively applying weighted least squares to the first set of filter coefficients to achieve an equiripple pattern in the passband, stopband or both of the IBR.

In some embodiments, determine the second set of filter coefficients further comprises iteratively applying weighted least squares to the first set of filter coefficients to achieve an equiripple pattern in the passband, stopband or both of the IBR.

In some embodiments, the IBR filter is further configured to apply a Kaiser window to the IBR having the first set of filter coefficients, the second set of filter coefficients, or both. In some embodiments, the first bitmap configuration or the second bitmap configuration is dynamically updated based on real-time network conditions or user requirements.

In some embodiments, the IBR filter is further comprising a feedback loop to adjust the first set of magnitude, second set of magnitudes, or both in response to detected interference levels.

In another aspect, the invention includes a non-transitory computer program product comprising instructions which, when the program is executed cause a processor to receive a first bitmap configuration that specifies active subchannels within the frequency band, determine a first set of magnitudes of a frequency response based on the first bit map configuration, determine a first set of filter coefficients for an IBR filter based on the first set of magnitudes, apply the IBR filter with the first set of filter coefficients to the frequency band to reject interference from inactive subchannels while allowing signals from active subchannels to pass through and receive a second bitmap configuration that specifies active subchannels within the frequency band. The non-transitory computer program product also comprises instructions which, when the program is executed cause a processor to determine a second set of magnitudes of a frequency response based on the first bit map configuration, determine a second set of filter coefficients for the IBR filter based on the first set of magnitudes, and apply the IBR filter with the second set of filter coefficients to the frequency band to reject interference from inactive subchannels while allowing signals from active subchannels to pass through, wherein the first bitmap configuration and the second bitmap configuration are different.

The non-transitory computer program, wherein subchannels within the frequency band are unequally spaced. The non-transitory computer program, wherein determine the first set of filter coefficients further comprises iteratively applying weighted least squares to the first set of filter coefficients to achieve an equiripple pattern in the passband, stopband or both of the IBR.

The non-transitory computer program product, wherein determine the second set of filter coefficients further comprises iteratively applying weighted least squares to the first set of filter coefficients to achieve an equiripple pattern in the passband, stopband or both of the IBR.

The non-transitory computer program, wherein the instructions further cause the processor to: apply a Kaiser window to the IBR having the first set of filter coefficients, the second set of filter coefficients, or both. The non-transitory computer program product, wherein the first bitmap configuration or the second bitmap configuration is dynamically updated based on real-time network conditions or user requirements.

### BRIEF DESCRIPTION OF THE DRAWINGS

Non-limiting examples of embodiments of the disclosure are described below with reference to figures attached hereto that are listed following this paragraph. Dimensions of features shown in the figures are chosen for convenience and clarity of presentation and are not necessarily shown to scale.

The subject matter regarded as the invention is particularly pointed out and distinctly claimed in the concluding portion of the specification. The invention, however, both as to organization and method of operation, together with objects, features and advantages thereof, can be understood by reference to the following detailed description when read with the accompanied drawings. Embodiments of the invention are illustrated by way of example and not limitation in the figures of the accompanying drawings, in which like reference numerals indicate corresponding, analogous or similar elements, and in which:

FIG. 1 is an example of a wireless communication system, according to some embodiments of the invention.

FIG. 2 is a flowchart for a method for an In-Band Rejection Filter (IBR) to filter varying combination of subchannels within a frequency band, according to some embodiments of the invention.

FIG. 3 is an example of subchannels, subchannels 1 through N, in a non-continuous band configuration, in accordance with some embodiments of the invention.

FIG. 4 shows a non-transition band of an IBR filter that can include disjoint bands, according to some embodiments of the invention.

FIG. 5 is a flowchart for a method for determining optimal weights for IBR filter coefficients, according to some embodiments of the invention.

FIG. 6 shows a block diagram of showing a flow for implementing a method for filter coefficients determination and using the filter coefficients in a convolution overlap method, according to some embodiments of the invention.

FIG. 7 is an example of an IBR filter rejection with a filter having filter coefficients determined as described above vs. without a filter, according to some embodiments of the invention.

It will be appreciated that for simplicity and clarity of illustration, elements shown in the figures have not necessarily been drawn accurately or to scale. For example, the dimensions of some of the elements can be exaggerated relative to other elements for clarity, or several physical components can be included in one functional block or element.

### DETAILED DESCRIPTION

In the following detailed description, numerous specific details are set forth in order to provide a thorough understanding of the invention. However, it will be understood by those skilled in the art that the invention can be practiced without these specific details. In other instances, well-known methods, procedures, and components, modules, units and/or circuits have not been described in detail so as not to obscure the invention.

In general, the invention involves a dynamic multiple band filter where filter coefficients can be determined for different bitmap configurations. The dynamic multiple band filter can be used in any wireless communication system, e.g., a point-to-point communication system, for example, PtMP wireless communication system communicating over a continuous band or a PLMR band, where the PLMR band can consist of adjacent or non-adjacent PLMR channels/subchannels. The PtMP wireless communication system can include a plurality of sectors where each sector has a base station and plurality of remote stations.

For a PtMP wireless communication system operating over a continuous band, e.g., a 1 MHz band, the fixed subchannel bandwidth can be any value that produces an integer number of subchannels within the total bandwidth. The total bandwidth can be divided into a large number of narrow subchannels. While the base station of the PtMP wireless communication system may communicate over the entire continuous band with many remotes at the same time, remotes serving low throughput applications may communicate over a few or even a single subchannel. Dividing the continuous band into subchannels can enable maintaining remote station to base station communication coverage with low transmit power which can reduce the cost of the remote station and/or its power consumption.

For a PtMP wireless communication system operating over a PLMR band, the fixed subchannel bandwidth can be equal to the bandwidth of a PLMR channel. The bandwidth of the subchannel may be equal to a portion of the bandwidth of the PLMR channel, in which case the fixed subchannel bandwidth can be any value that produces an integer number of subchannels to fit the bandwidth of one PLMR channel. The frequency boundaries of the subchannels can be aligned with the frequency boundaries of the PLMR channels.

A subchannel bit map can be constructed such that it spans the frequency range of the entire band and indicates the availability of each of the subchannels for communication. In this manner, the subchannel bit map can define the availability over the frequency range of the total bandwidth of the PtMP wireless communication system. The subchannel bit map can be populated for each sector in the PtMP wireless system, and can define availability of all of the subchannels for each sector.

For a PtMP wireless communication system operating over a PLMR band, the subchannel bit map can be configured at each sector such that the subchannels that correspond in frequency to unavailable PLMR channels are turned off and the remainder of the subchannels are turned on, and can be further evaluated for availability based on other factors as described below (e.g., depending on frequency reuse considerations, e.g., whether they are used in other sectors and there may be self-interference between the sectors)

For a PtMP wireless communication system operating over a PLMR band, the subchannel bit map can be configured at each sector such that a) subchannels corresponding to PLMR channels not available to the system are turned off and b) subchannels available to the system may be turned on or off, depending on frequency reuse considerations, e.g., whether they are used in other sectors and there may be self-interference between the sectors.

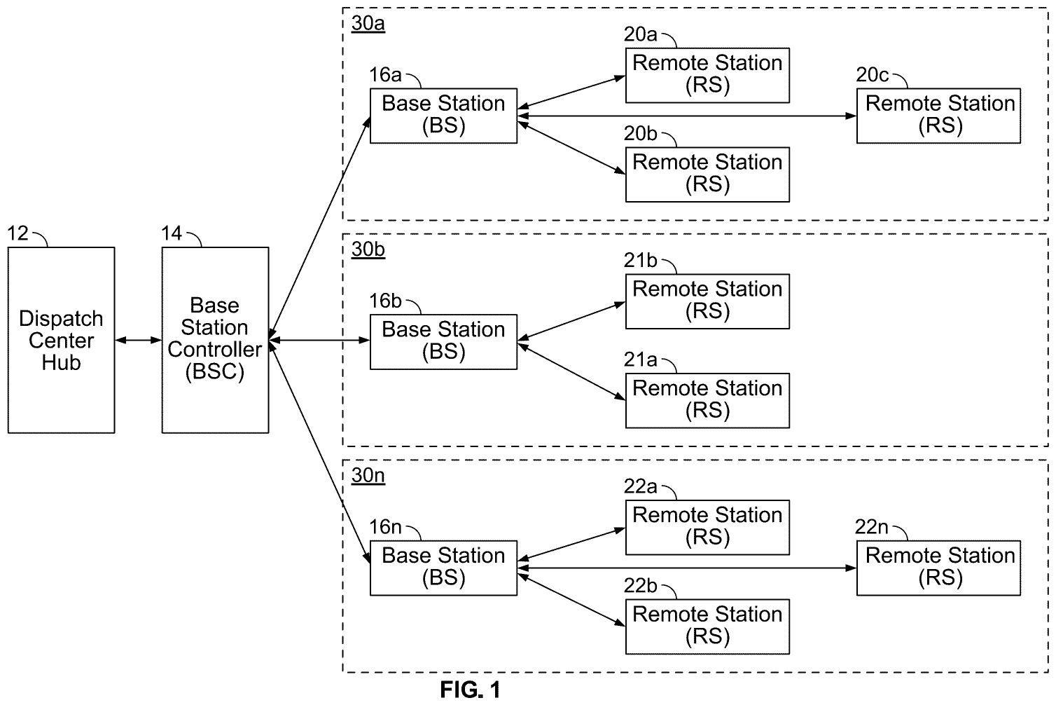

FIG. 1 is an example of a PtMP wireless communication system 100, according to some embodiments of the invention. The PtMP wireless communication system 100 includes a dispatch center hub 12, a base station controller 14, and a plurality of sectors 30a, 30b, . . . 30n, generally sectors 30.

The dispatch center hub 12 can communicate with the base station controller 14. In some embodiments, the base station controller 14 is not present, and the dispatch center hub 12 communicates directly with each of the sectors 30.

Each of the plurality of sectors has a base station and a plurality of remote stations. As shown in FIG. 1, sector 30a includes base station 16a, and three remote stations 20a, 20b, and 20b. Sector 30b includes base station 16b, and two remote stations 21a and 21b. Sector 30n includes base station 16n and remote stations 22a, 22b, . . . , 22n. In various embodiments, the PtMP wireless communication system 100 can have any number of sectors, and each sector can have any number of base stations and/or remote stations.

In some embodiments, the PtMP wireless communication system 100 has a plurality of cells (not shown). Each cell in the plurality of cells can include an area served by one tower site that is located at a center of the cell. The cell can have one sector or be partitioned into multiple sectors. For example, the PtMP wireless communication system can have a cell with three sectors, where each sector covers 120° of the cell. A sector can be served by a single sector base station or a multisector base station can be used to support multiple sectors in the cell.

The PtMP wireless communication system 100 can be a private or public wireless communication system. The PtMP wireless communication system 100 can have one or more PLMR channels assigned by the FCC or by any national spectrum regulation agency outside of the US.

A plurality of subchannels can be determined for the PtMP wireless communication system 100 (e.g., as described in co-pending U.S. application Ser. No. 18/299,378 filed on Apr. 12, 2023, incorporated herein by reference in its entirety). Each base station 16a, 16b, . . . , 16n can transmit and receive signals in all or a subset of the subchannels available to the system. Each remote station in each of the sectors 30 can transmit and receive in a subset of the subchannels available to the sector (e.g., a subset of the subchannel available to the sector may be a single subchannel or a plurality of the subchannels).

In some embodiments, limiting the remote station to transmit over a subset of the subchannels available to the sector can help reduce cost and/or power consumption of the remote station. For example, assume a base station operates over 80 subchannels with a fixed subchannel bandwidth of 12.5 KHz, resulting in a bandwidth for the sector served by the base station of 1 MHz. In this example, assume a remote station communicates with the base station over only a single subchannel. In this example, the base station and remote station coverage is the same with a ratio of 10 log 80=19 dB difference between the transmit power level of the base station and this remote, e.g., if the base station transmits at 45 dBm, the remote station that transmits only over a single subchannel can transmit at a only 26 dBm. In this manner, the cost and power consumption of the remote station can be reduced. In this embodiment, where the remote station communicates over a single subchannel and not over multiple non-adjacent channels, a simple bandpass filter instead of a complex filter can be used which can further reduces complexity and cost.

The PtMP wireless communication system can employ Time Division Duplex or Half Duplex Frequency Division Duplexing (FDD) or FDD. If the PtMP wireless communication system employs TDD, it can support an extreme asymmetrical DL:UL ratio in the range of 1:10 to 10:1 which can help improve frequency utilization in asymmetrical and reverse asymmetrical application.

The base station can employ Orthogonal Frequency Division Multiplexing (OFDM) in the downlink direction (from the base station to the remote stations) The number of subcarriers per subchannel may be one or multiple. As an example, the system may employ 512 subcarriers in the downlink direction which can be used to partition into 512 subchannels, each employing a single subcarrier.

The PtMP remote station can employ either single carrier or Single Carrier OFDMA (SC-FDMA) to communicate with the base station in the uplink direction. A remote station can employ single carrier if it communicates with the base station over a single subchannel and SC-FDMA if it communicates with the base station over multiple adjacent or non-adjacent sub-channels.

In some embodiments, the PLMR channel bandwidths can be 5 KHz, 6.25 KHz, 7.5 KHz, 12.5 KHz, 15 KHz, 25 KHz or 50 KHz.

Each base station 16a, 16b, . . . 16n, can transmit and receive electromagnetic signals (e.g., radio frequency (RF)) signals via its own local antenna. Each remote station 20a, 20b, 20c, 21a, 21b, 22a, 22b, . . . 22n, can transit and receive RF signals via its own local antenna.

The base stations 16a, 16b, . . . 16n, and/or the remote stations 20a, 20b, 20c, 21a, 21b, 21c, 22a, 22b, and 22c can include an In-Band Rejection Filter (IBR).

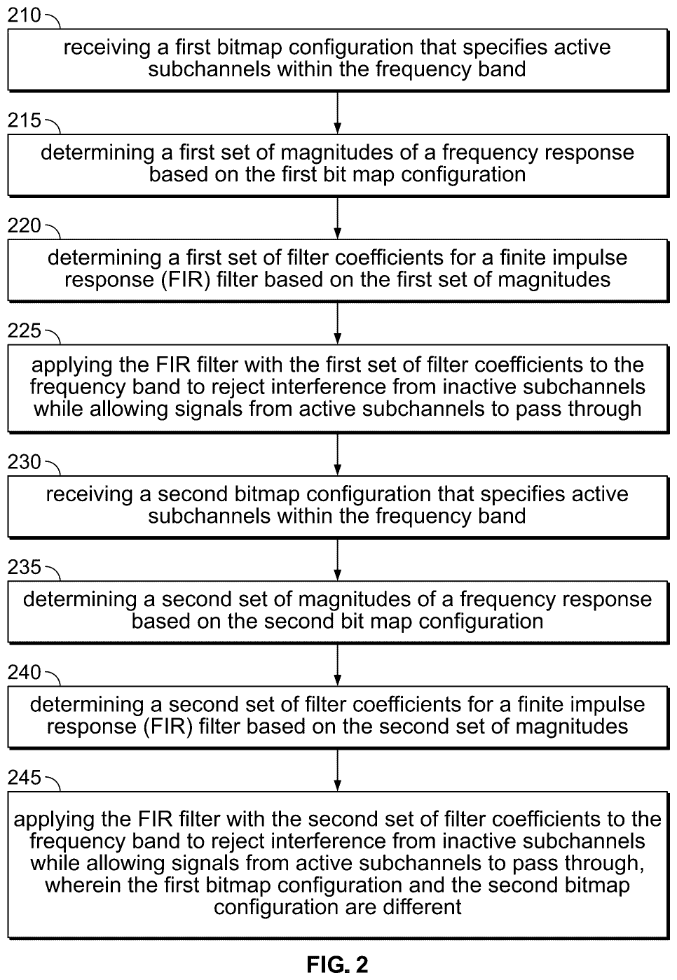

FIG. 2 is a flow chart for a method for an In-Band Rejection Filter (IBR) to filter (e.g., an IBR filter in a RS and/or BS as shown above in FIG. 1) varying combination of subchannels within a frequency band, according to some embodiments of the invention. The IBR filter can be an FIR filter.

The method can involve receiving a first bitmap configuration that specifies active subchannels within the frequency band (Step 210).

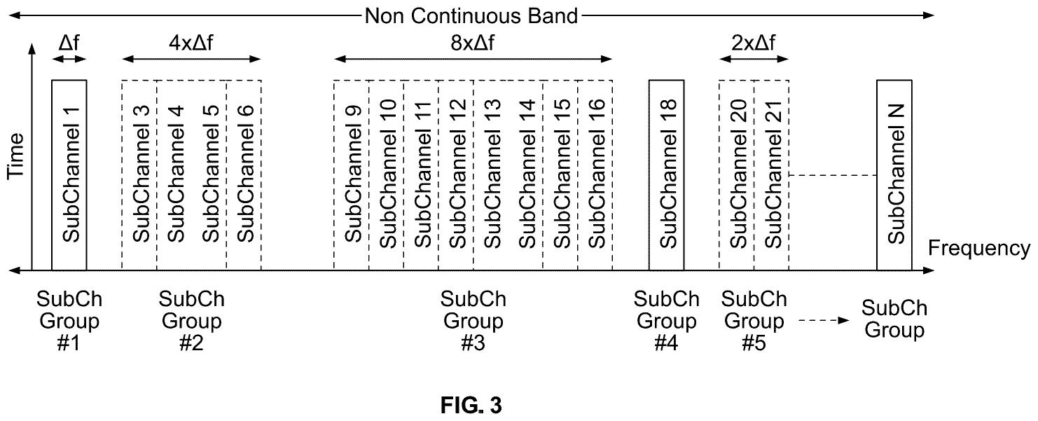

FIG. 3 is an example of subchannels, subchannels 1 through N, in a non-continuous band configuration, in accordance with some embodiments of the invention. Some of the subchannels are adjacent, some of the subchannels stand alone, and some of the subchannels are not available. The first bitmap configuration can correspond to the available subchannels as shown in FIG. 3.

The method can involve determining a first set of magnitudes of a frequency response based on the first bit map configuration (Step 215). The first set of magnitudes can be determined as shown below in EQN. 1 as follows: given a IBR filter length of 2M+1, where M is the a total number of one-sided filter frequency tones, specify the magnitude frequency response for the normalized frequency range from 0 to p:

$${H}_{k} at {Ω}_{k} = \frac{2 π k}{( 2 M + 1 )} for k = 0 , 1 , … , M . \qquad EQN . 1$$

where k is the filter frequency tone index, Hₖ is a magnitude response at filter frequency tone k, and H₀ is the magnitude response of the center frequency.

The method can involve determining a first set of filter coefficients for the IBR filter based on the first set of magnitudes (Step 220). The first set of filter coefficients for the IBR can be determined as shown below in EQN. 2 as follows:

$$h ( n ) = \frac{1}{2 M + 1} \{ {H}_{0} + 2 {\sum }_{k = 1}^{M} {H}_{k} cos ( \frac{2 π k ( n - M )}{2 M + 1} ) \} for n = 0 , 1 , … , M . \qquad EQN . 2$$

The first set of filter coefficients can be half of the filter coefficients. A mirror image of the set of filter coefficients can be determined to, for example, ensure the IBR filter maintains a linear phase response of real valued coefficients. Symmetry can be used to determine remaining coefficients as shown below in EQN. 3 as follows:

$$h ( n ) = h ( 2 M - n ) for n = M + 1 , … , 2 M . \qquad EQN . 3$$

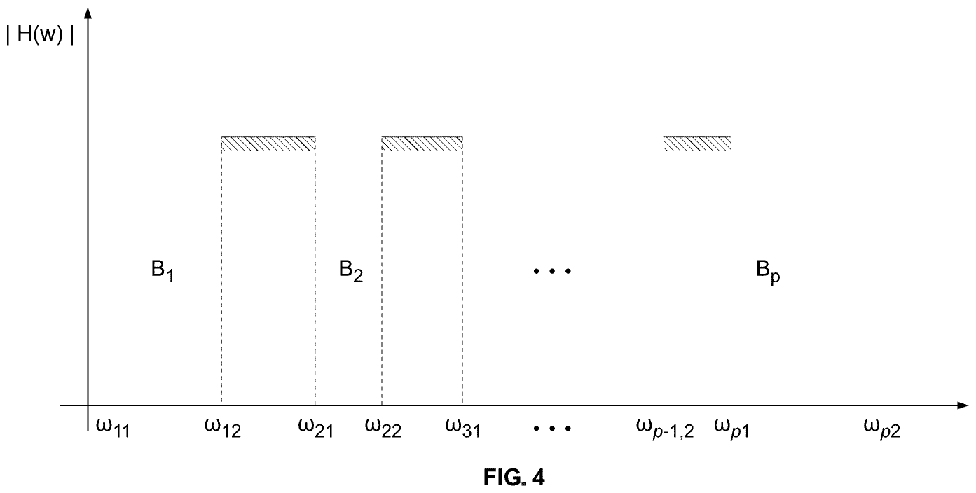

In some embodiments, the first set of filter coefficients can be determined as described below in relation to FIG. 4 as follows: turning to FIG. 4, FIG. 4 shows a non-transition band B_{NT} of the IBR filter that can include p disjoint bands, according to some embodiments of the invention. The filter coefficients can be determined as shown below:

$${B}_{N T} = {B}_{1} ⋃ {B}_{2} ⋃ … {B}_{p} \qquad EQN . 4$$

$$where :$$

$${B}_{m} = \{ {ω}_{m 1} \leq ω \leq {ω}_{m 2} \vert m = 1 , … , p \} \qquad EQN . 5$$

where ωₘ₁ and ωₘ₂ denotes the cutoff frequencies of the m^{th} frequency band. The union of transition band, denoted B_{TS}, can be as shown in EQN. 6:

$${B}_{T s} = \{ 0 \leq ω \leq π \vert ω ∉ {B}_{N T} \} \qquad EQN . 6$$

Assume that the filter to be designed is (M−1)th order IBR filter with real filter coefficients h(n), the filter frequency response H(ω) can be as shown in EQN. 7:

$$H ( ω ) = \text{} {\sum }_{n = 0}^{M - 1} h ( n ) {e}^{- j ω n} = {\sum }_{n = 0}^{M - 1} h ( n ) cos ( 2 πω n ) - j h ( n ) sin ( 2 πω n ) \qquad EQN . 7$$

The complex approximation error E(ω) can be as shown in EQN. 8:

$$E ( ω ) = {H}_{d} ( ω ) - H ( ω ) = {E}_{r} ( ω ) + j {E}_{i} ( ω ) ω ∈ {B}_{N T} \qquad EQN . 8$$

where Eᵣ and Eᵢ are the real and imaginary parts of E, respectively.

Let Wₑ(ω) with ω∈B_{NT} be a piecewise constant function associated with the desired relative approximation error ratio among the p frequency bands, as shown in EQN. 9 and EQN 10.

$${W}_{e} ( ω ) = {ρ}_{m} if ω ∈ {B}_{m} \qquad EQN . 9$$

$$where :$$

$${ρ}_{m} > 0 for m = 1 , … , p max \{ {ρ}_{1} , {ρ}_{2} , … , {ρ}_{p} \} = 1 \qquad EQN . 10$$

where the ratio 1/ρ₁: 1/ρ₂: . . . : 1/ρₚ denotes the desired relative approximation error ratio among B₁, B₂, . . . , Bₚ.

The set of filter coefficients h(n) can be determined via the weighted least sum (WLS) estimation (as shown in EQN. 17 below), such that H(ω) can be equiripple with δ₁: δ₂: . . . : δₚ=1/ρ₁: 1/ρ₂: . . . : 1/ρₚ, where δₘ is the maximum approximation error in Bₘ.

For notation simplicity, let H_{d}(k), Wₑ(k), E(k), Eᵣ(k), Eᵢ(k) denote H_{d}(ω=k/2N), Wₑ(ω=k/2N), E(ω=k/2N), Eᵣ(kω=k/2N), Eᵢ(ω=k/2N), respectively, where 2N is the total number of samples in the interval [0,1]. Using the notation, EQN. 7 and EQN. 8, Eᵣ(k) and Eᵢ(k) can be expressed as a linear vector form for k=0, 1, . . . , N−1 as shown below in FIG. 11:

$$[ \begin{matrix}{E}_{r} \\ {E}_{i}\end{matrix} ] = [ \begin{matrix}Re ( {H}_{d} ) \\ Im ( {H}_{d} )\end{matrix} ] - [ \begin{matrix}{D}_{1} \\ {D}_{2}\end{matrix} ] h \qquad EQN . 11$$

where Re(H_{d}) and Im(H_{d}) denote the real and imaginary parts of H_{d}, respectively, and

$$h = {[ h ( 0 ) , h ( 1 ) , … , h ( M - 1 ) ]}^{T} \qquad EQN . 12$$

$$E = {[ E ( 0 ) , E ( 1 ) , … , E ( N - 1 ) ]}^{T} \qquad EQN . 13$$

$${H}_{d} = {[ {H}_{d} ( 0 ) , {H}_{d} ( 1 ) , … , {H}_{d} ( N - 1 ) ]}^{T} \qquad EQN . 14$$

and D1 and D2 are N×M matrices defined by the (k,l)th element as

$${[ {D}_{1} ]}_{k l} = cos ( k - 1 ) ( l - 1 ) π / N \qquad EQN . 15$$

$${[ {D}_{2} ]}_{k l} = - sin ( k - 1 ) ( l - 1 ) π / N \qquad EQN . 16$$

The sum of weighted error squares is defined as:

$$\begin{matrix}J ( h ) = {\sum }_{k = 0}^{N - 1} w ( k ) {\vert E ( k ) \vert}^{2} \\ = {[ \begin{matrix}{E}_{r} \\ {E}_{i}\end{matrix} ]}^{T} [ \begin{matrix}W & 0 \\ 0 & W\end{matrix} ] [ \begin{matrix}{E}_{r} \\ {E}_{i}\end{matrix} ]\end{matrix} \qquad EQN . 17$$

where W=diag[w(0), w(1), w(2), . . . , w(N−1)] with w(k)≥0 for all 0≤k≤N−1.

The weighted least sum estimate h of h which minimizes J(h) can be

$$\hat{h} = {[ {D}^{T} {W}_{1} D ]}^{- 1} {D}^{T} {W}_{1} [ \begin{matrix}Re ( {H}_{d} ) \\ Im ( {H}_{d} )\end{matrix} ] \qquad EQN . 18$$

$$where$$

$${D}^{T} = [ \begin{matrix}{D}_{1}^{T} & {D}_{2}^{T}\end{matrix} ]$$

$$and$$

$${W}_{1} = diag ( W , W )$$

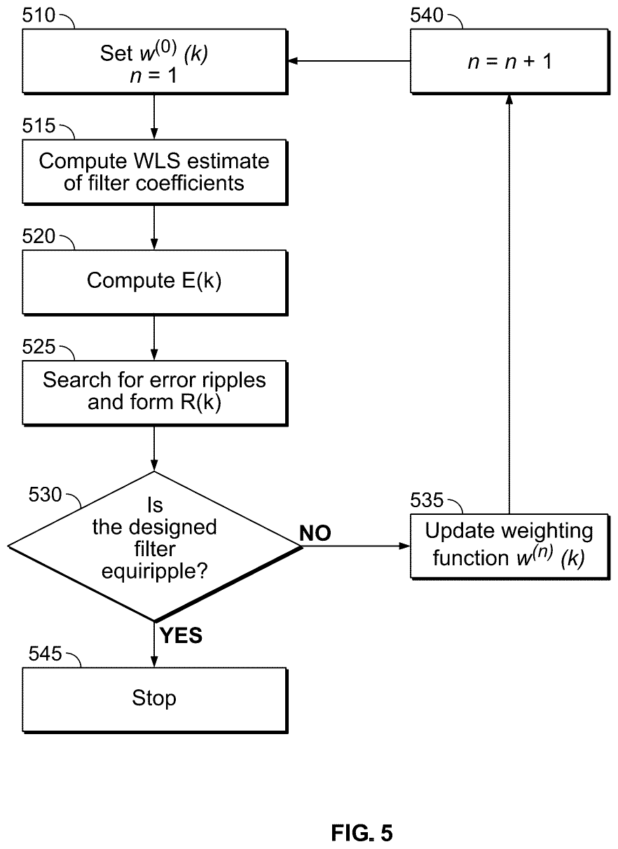

In some embodiments, weights for filter coefficients can be determined. The weights for the filter coefficients can be determined such that they are optimal (e.g., such that the IBR filter exhibits an equiripple behavior in its passband). In some embodiments, the weights for the filter coefficient can be determined based on an approximation method. The approximation method can be as determined as shown in FIG. 5. Turning to FIG. 5, FIG. 5 is a flowchart for a method for determining optimal weights for IBR filter coefficients (e.g., FIR filter coefficients), according to some embodiments of the invention. The method of FIG. 5 can be an iterative method where weighted least sum estimator that causes the larger the weight w(k), the smaller the absolute approximation error |E(k)|. The objective can be to find optimum weights w(k) such that a weighted ripple errors, |Wₑ(k) E(k)|, is equiripple with a desired approximation error ratio for k/2N∈B_{NT}.

The method can involve determining an initial weighing function (Step 510) and setting n, which can be a real number that indicates the number of iterations based on convergence or a predetermined maximum number of iterations is met, as shown below in EQN. 19:

$${w}^{0} ( k ) = \{ \begin{matrix}{W}_{e} ( k ) & k / 2 N ∈ {B}_{NT} \\ 0 & k / 2 N ∈ {B}_{TS}\end{matrix} \qquad EQN . 19$$

After n−1 iterations, the weighing function can be represented as wⁿ⁻¹(k).

For each nth iteration, the method can involve determining a weighted least sum estimate of the filter coefficients h, ĥ, (Step 515) to minimize J(h) via EQN. 18, as described above, where:

$$W = diag [ {w}^{n - 1} ( 0 ) , w ( 1 ) , {w}^{n - 1} ( 2 ) , ⋯ , {w}^{n - 1} ( N - 1 ) ] \qquad EQN . 20$$

The method can involve determining the associated absolute approximation error |E(k)| (Step 520), for example, using EQN. 17 as described above.

The method can involve determining error ripples, e.g., a total number of deviations from a desired frequency response, and form R(k) (Step 525), as follow: For m=1, . . . , p find the error ripples

$${E}_{m}^{i} ( k )$$

### (Step 525):

$$\begin{matrix}{E}_{m}^{i} ( k ) = \vert E ( k ) \vert & k / 2 N ∈ {B}_{m}^{i}\end{matrix} \qquad EQN . 21$$

For i=1, 2, . . . , q where q is the total number of error ripples in Bₘ and

$${B}_{m}^{i} = \{ ω \vert {ω}_{m}^{i - 1} \leq ω \leq {ω}_{m}^{i} \} ⊂ {B}_{m} \qquad EQN . 22$$

where

$${ω}_{m}^{0} = {ω}_{m 1} , {ω}_{m}^{q} = {ω}_{m 2}$$

and for each 0<i<q,

$${ω}_{m}^{i}$$

is the frequency at which E(ω) is a local minimum.

Denote

$${e}_{m}^{i} ,$$

the amplitude of error ripple

$${E}_{m}^{i} ( i ) ,$$

as follows:

$${e}_{m}^{i} = max \{ {E}_{m}^{i} ( k ) \vert k / 2 N ∈ {B}_{m}^{i} \} \qquad EQN . 23$$

Form the piecewise constant function R(k) for k/2N∈B_{NT}

$$\begin{matrix}R ( k ) = {ρ}_{m} {e}_{m}^{i} & if\end{matrix} k / 2 N ∈ {B}_{m}^{i} \qquad EQN . 24$$

The method can involve determining if the weighted ripple errors are equiripple (Step 520), by determining whether the weighted ripple errors |Wₑ(k)E(k)| for k/2N∈B_{NT} are equiripple by:

$$\frac{{R}_{max} - {R}_{min}}{{R}_{max}} \leq σ \qquad EQN . 25$$

where σ is a ripple tolerance, e.g., predetermined positive constan)t, where the ripple tolerance can be an upper limit on a relative fluctuation between maximum and minimum values or R; if the ripple tolerance is small, this can indicate that the ripple (e.g., fluctuation) is R is tightly controlled, which can ensure stability and consistency; if the ripple tolerance is large, R has a greater fluctuation, indicating higher permissible variation in R, range can be from 0 to 1, and

$${R}_{max} = max \{ R ( k ) \vert k / 2 N ∈ {B}_{NT} \} \qquad EQN . 26$$

$${R}_{min} = min \{ R ( k ) \vert k / 2 N ∈ {B}_{NT} \} \qquad EQN . 27$$

I Whether or not the weighted ripple errors |Wₑ(k)E(k)| are equiripple can be checked (Step 530). If weighted ripple errors are not equiripple, the weighting function can be updated (Step 535) and the process continues until the equiripple filter satisfying predetermined magnitude and phase specifications is met, are obtained (Step 540), as follows:

$${w}^{n} ( k ) = \{ \begin{matrix}{w}^{n - 1} ( k ) R ( k ) / {w}_{max} & k / 2 N ∈ {B}_{NT} \\ 0 & k / 2 N ∈ {B}_{TS}\end{matrix} \qquad EQN . 28$$

$$where$$

$${w}_{max} = max \{ {w}^{n - 1} ( k ) R ( k ) \vert k / 2 N ∈ {B}_{NT} \} .$$

If weighted ripple errors are equiripple, the process can stop and the weighted ripple errors |Wₑ (k)E(k)| can be determined as optimum and/or complete (Step 545).

Turning back to FIG. 2, the method can involve applying the IBR filter with the first set of filter coefficients to the frequency band to reject interference from inactive subchannels while allowing signals from active subchannels to pass through (Step 225).

The method can involve receiving a second bitmap configuration that specifies active subchannels within the frequency band (Step 230). The second bitmap configuration can be different from the first bitmap configuration. For example, if a radio is handed over to a different base station, or dynamic subchannel switching based on interference and/or capacity can be done a second different bitmap can be needed.

The method can involve determining a second set of magnitudes of a frequency response based on the second bit map configuration (Step 235). The second set of magnitudes can be determined as described above with respect to Step 215.

The method can involve determining a second set of filter coefficients for the IBR filter based on the first set of magnitudes (Step 240). The second set of filter coefficients can be determined as described above with respect to Step 220.

The method can involve applying the IBR filter with the second set of filter coefficients to the frequency band to reject interference from inactive subchannels while allowing signals from active subchannels to pass through, wherein the first bitmap configuration and the second bitmap configuration are different (Step 245).

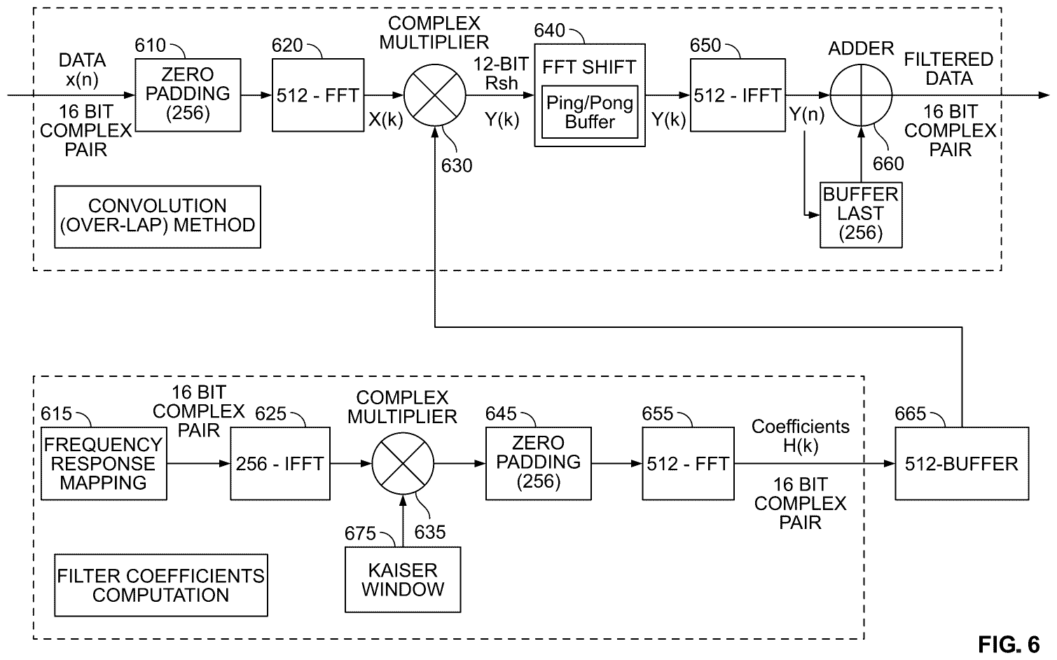

FIG. 6 shows a block diagram of showing a flow for implementing a method for filter coefficients determination and using the filter coefficients in a convolution overlap method, according to some embodiments of the invention.

The overlap-add method for convolution can allow the use of a Discrete Fourier Transform (DFT)-based method for determining the convolution of very long sequences (e.g., 256 or 512). Fast Fourier Transform (FFT) convolution can use the principle that multiplication in the frequency domain can correspond to convolution in the time domain. The input signal can be transformed into the frequency domain using the DFT, multiplied by the frequency response of the filter, and then transformed back into the time domain using the Inverse DFT. The over-lap method for convolution can be as follows:

The data, data block x(n) can be transmitted (e.g., a 16 bit complex pair). The length ‘M’ of an impulse response filter can be determined. A N-point FFT of impulse sequence can be taken, where N=2*(M). The length of the data block taken at each iteration (e.g., ‘L=M’) can be determined, where L is the filter length.

The method can involve padding each data block by padding ‘M−1’ zeros (Step 610). The method can involve determining N-point FFT's of each data block (Step 620). The method can involve multiplying the filter coefficients with output of the N-point FFT (Step 630).

The filter coefficients used in step 630 can be determined by the filter coefficients computation, and can involve a frequency response mapping (Step 615) that maps a subchannel infex to a filter frequency tone index in the frequency domain. An Inverse Fast Fourier Transform (IFFT) can be performed on the mapped values (Step 625). A Kaiser window (Step 675) can be applied to the IFFT of the mapped values using a complex multiplier (Step 635). Zero padding (Step 645) can be applied, followed by a Fast Fourier Transform (FFT) (Step 665) to obtain the coefficients H(k). The coefficients can be buffered (Step 665) prior to inputting to the complex multiplier of the convolution overlap method (Step 630).

The result of multiplying the filter coefficients with output of the N-point FFT can be shifted by a FFT (Step 640). An N-point IFFT can be applied to the shifted FFT data (Step 650). The output of the N-point IFFT applied to the shifted FFT data can be filtered.

Is the output significant to show? See FIGS. 21 and 22 in the provisional as filed. What are these conveying in terms of the output?

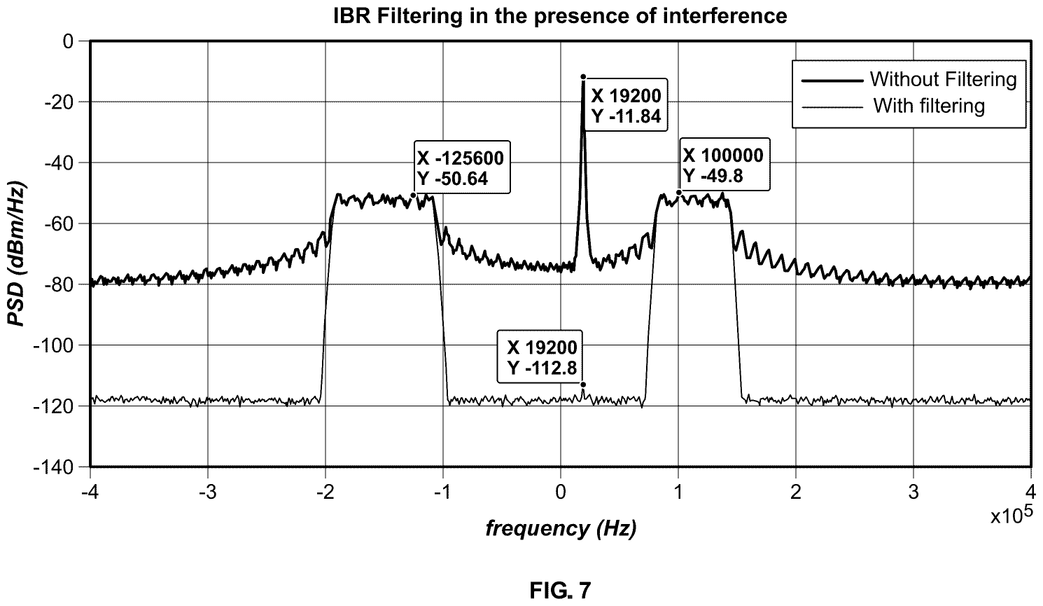

FIG. 7 is an example of an IBR filter rejection with a filter having filter coefficients determined as described above vs. without a filter, according to some embodiments of the invention.

In some embodiments, a kaiser window is used with the IBR filter.

One skilled in the art will realize the invention can be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

In the foregoing detailed description, numerous specific details are set forth in order to provide an understanding of the invention. However, it will be understood by those skilled in the art that the invention can be practiced without these specific details. In other instances, well-known methods, procedures, and components, modules, units and/or circuits have not been described in detail so as not to obscure the invention. Some features or elements described with respect to one embodiment can be combined with features or elements described with respect to other embodiments.

Although embodiments of the invention are not limited in this regard, discussions utilizing terms such as, for example, “processing,” “computing,” “calculating,” “determining,” “establishing”, “analyzing”, “checking”, or the like, can refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that can store instructions to perform operations and/or processes.

Although embodiments of the invention are not limited in this regard, the terms “plurality” and “a plurality” as used herein can include, for example, “multiple” or “two or more”. The terms “plurality” or “a plurality” can be used throughout the specification to describe two or more components, devices, elements, units, parameters, or the like. The term set when used herein can include one or more items. Unless explicitly stated, the method embodiments described herein are not constrained to a particular order or sequence. Additionally, some of the described method embodiments or elements thereof can occur or be performed simultaneously, at the same point in time, or concurrently.

What is claimed is:

1. A method for an In-Band Rejection Filter (IBR) to filter varying combination of subchannels within a frequency band, comprising:
receiving, by a processor, a first bitmap configuration that specifies active subchannels within the frequency band;
determining, by the processor, a first set of magnitudes of a frequency response based on the first bit map configuration;
determining, by the processor, a first set of filter coefficients for the IBR filter based on the first set of magnitudes;
applying, by the processor, the IBR filter with the first set of filter coefficients to the frequency band to reject interference from inactive subchannels while allowing signals from active subchannels to pass through; and
receiving, by the processor, a second bitmap configuration that specifies active subchannels within the frequency band;
determining, by the processor, a second set of magnitudes of a frequency response based on the first bit map configuration;
determining, by the processor, a second set of filter coefficients for the IBR filter based on the first set of magnitudes; and
applying, by the processor, the IBR filter with the second set of filter coefficients to the frequency band to reject interference from inactive subchannels while allowing signals from active subchannels to pass through,
wherein the first bitmap configuration and the second bitmap configuration are different.

2. The method of claim 1 wherein subchannels within the frequency band are unequally spaced.

3. The method of claim 1 wherein determining the first set of filter coefficients further comprises iteratively applying, by the processor, weighted least squares to the first set of filter coefficients to achieve an equiripple pattern in the passband, stopband or both of the IBR.

4. The method of claim 1 wherein determining the second set of filter coefficients further comprises iteratively applying, by the processor, weighted least squares to the first set of filter coefficients to achieve an equiripple pattern in the passband, stopband or both of the IBR.

5. The method of claim 1 further comprising: applying, by the processor, a Kaiser window to the IBR having the first set of filter coefficients, the second set of filter coefficients, or both.

6. The method of claim 1, wherein the first bitmap configuration or the second bitmap configuration is dynamically updated based on real-time network conditions or user requirements.

7. The method of claim 4, further comprising a feedback loop to adjust the first set of magnitude, second set of magnitudes, or both in response to detected interference levels.

8. An In-Band Rejection Filter (IBR) to filter varying combination of subchannels within a frequency band, comprising:
one or more processors configured to:
receive a first bitmap configuration that specifies active subchannels within the frequency band;
determine a first set of magnitudes of a frequency response based on the first bit map configuration;
determine a first set of filter coefficients for the IBR filter based on the first set of magnitudes;
apply the IBR filter with the first set of filter coefficients to the frequency band to reject interference from inactive subchannels while allowing signals from active subchannels to pass through; and
receive a second bitmap configuration that specifies active subchannels within the frequency band;
determine a second set of magnitudes of a frequency response based on the first bit map configuration;
determine a second set of filter coefficients for the IBR filter based on the first set of magnitudes; and
apply the IBR filter with the second set of filter coefficients to the frequency band to reject interference from inactive subchannels while allowing signals from active subchannels to pass through,
wherein the first bitmap configuration and the second bitmap configuration are different.

9. The IBR filter of claim 8 wherein subchannels within the frequency band are unequally spaced.

10. The IBR filter of claim 8 wherein determine the first set of filter coefficients further comprises iteratively applying weighted least squares to the first set of filter coefficients to achieve an equiripple pattern in the passband, stopband or both of the IBR.

11. The IBR filter of claim 8 wherein determine the second set of filter coefficients further comprises iteratively applying weighted least squares to the first set of filter coefficients to achieve an equiripple pattern in the passband, stopband or both of the IBR.

12. The IBR filter of claim 8 further comprising: applying a Kaiser window to the IBR having the first set of filter coefficients, the second set of filter coefficients, or both.

13. The IBR filter of claim 8, wherein the first bitmap configuration or the second bitmap configuration is dynamically updated based on real-time network conditions or user requirements.

14. The IBR filter of claim 11, further comprising a feedback loop to adjust the first set of magnitude, second set of magnitudes, or both in response to detected interference levels.

15. A non-transitory computer program product comprising instructions which, when the program is executed cause a processor to:
receive a first bitmap configuration that specifies active subchannels within the frequency band;
determine a first set of magnitudes of a frequency response based on the first bit map configuration;
determine a first set of filter coefficients for an IBR filter based on the first set of magnitudes;
apply the IBR filter with the first set of filter coefficients to the frequency band to reject interference from inactive subchannels while allowing signals from active subchannels to pass through; and
receive a second bitmap configuration that specifies active subchannels within the frequency band;
determine a second set of magnitudes of a frequency response based on the first bit map configuration;
determine a second set of filter coefficients for the IBR filter based on the first set of magnitudes; and
apply the IBR filter with the second set of filter coefficients to the frequency band to reject interference from inactive subchannels while allowing signals from active subchannels to pass through,
wherein the first bitmap configuration and the second bitmap configuration are different.

16. The non-transitory computer program product of claim 15 wherein subchannels within the frequency band are unequally spaced.

17. The non-transitory computer program product of claim 15 wherein determine the first set of filter coefficients further comprises iteratively applying weighted least squares to the first set of filter coefficients to achieve an equiripple pattern in the passband, stopband or both of the IBR.

18. The non-transitory computer program product of claim 15 wherein determine the second set of filter coefficients further comprises iteratively applying weighted least squares to the first set of filter coefficients to achieve an equiripple pattern in the passband, stopband or both of the IBR.

19. The non-transitory computer program product of claim 15 wherein the instructions further cause the processor to: apply a Kaiser window to the IBR having the first set of filter coefficients, the second set of filter coefficients, or both.

20. The non-transitory computer program product of claim 15 wherein the first bitmap configuration or the second bitmap configuration is dynamically updated based on real-time network conditions or user requirements.
